(19) United States
(12) Patent Application Publication
(10) Pub. No.: US 2010/0299509 A1
(43) Pub. Date: Nov. 25, 2010

(54) SIMULATION SYSTEM, METHOD AND PROGRAM

(75) Inventors: Jun Doi, Kanagawa (JP); Shuichi Shimizu, Kanagawa (JP); Takeo Yoshizawa, Kanagawa (JP)

Correspondence Address: IBM CORPORATION, T.J. WATSON RESEARCH CENTER, P.O. BOX 218, YORKTOWN HEIGHTS, NY, 10598, US

(73) Assignee: INTERNATIONAL BUSINESS MACHINES CORPORATION, Armonk, NY (US)

(21) Appl. No.: 12/781,874

(22) Filed: May 18, 2010

(30) Foreign Application Priority Data
May 19, 2009 (JP) 2009-120575

(51) Int. Cl. G06F 9/38

(52) U.S. Cl. 712/241; 712/E09.045

(57) ABSTRACT

A computer-implemented pipeline execution system, method, and program product for executing loop processing in a multi-core or a multiprocessor computing environment, where the loop processing includes multiple function blocks in a multiple-stage pipeline manner. The system includes: a pipelining unit for pipelining the loop processing and assigning the loop processing to a computer processor or core; a calculating unit for calculating a first-order gradient term from a value calculated with the use of a predicted value of the input to a pipeline; and a correcting unit for correcting an output value of the pipeline with the value of the first-order gradient term.

### CROSS-REFERENCE TO RELATED APPLICATIONS

This application claims priority under 35 U.S.C. §119 to Japanese Patent Application No. 2009-120575 filed May 19, 2009, the entire contents of which are incorporated by reference herein.

### BACKGROUND OF THE INVENTION

1. Field of the Invention

The present invention relates to a technique for executing simulation in a multi-core or multiprocessor system.

2. Description of the Related Art

Recently, in the fields of scientific and technical calculation, multiprocessor systems are used for performing simulations. In such systems, an application program generates multiple processes and assigns the processes to individual processors. The processors proceed with processing while communicating with one another, for example, using inter-process message exchange like MPI (Message Passing Interface) exchange and using a shared memory space.

The field of simulation, which has been recently developed, includes software for simulation for a mechatronics plant for robot, automobile, airplane and the like. In robots, automobiles, airplanes and the like, most of the controls are electronically performed by using wire connections stretched around like nerves or a wireless LAN.

Although they are originally mechanical apparatuses, they also include a lot of control software. As a result, the development and testing phases of a product control program is costly, requiring much time and resources.

One technique which has been conventionally used for testing is HILS (Hardware In the Loop Simulation). An environment for testing an electronic control unit (ECU) of a whole automobile is called full-vehicle HILS. In the full-vehicle HILS, a real ECU is connected to a dedicated hardware apparatus for emulating an engine, a transmission mechanism and the like in a laboratory, and a test is performed in accordance with a predetermined scenario. An output from the ECU is inputted to a computer for monitoring and further displayed on a display. A person in charge of the test checks whether there is any abnormal operation by looking at the display.

However, in the HILS, because it is necessary to use a dedicated hardware apparatus and physically perform wiring between the hardware apparatus and a real ECU, much preparation is required. Furthermore, when a test is performed by exchanging the ECU to another one, it is also difficult because physical reconnection is required. Furthermore, since a real ECU is used in the test, actual time is required. Therefore, when a lot of scenarios are tested, a great amount of time is required. Furthermore, the hardware apparatus for HILS emulation is generally very expensive.

Recently, a method has been proposed for making a configuration with software without using the expensive hardware apparatus for emulation. This method is called SILS (Software In the Loop Simulation), in which an entire plant, including a microcomputer, an input/output circuit, a control scenario, an engine, a transmission and the like to be mounted on an ECU, is configured by a software simulator. According to this method, it is possible to execute a test without ECU hardware.

As an example is provided of a system for supporting construction of such SILS, for example, MATLAB®/Simulink®, which is a simulation modeling system developed by the MathWorks, Inc. By using MATLAB®/Simulink®, it is possible to create a simulation program by arranging function blocks A, B, . . . , G and specifying the flow of processing using arrows on a screen via a graphical interface, as shown in FIG. 1. In general, a block diagram in MATLAB®/Simulink® describes a behavior of a system targeted by simulation during one time step. By repeatedly calculating the behavior during a specified time, a behavior of the system in a time series is obtained.

In simulating a control system, a model often includes a loop because feedback control is often used. Among the function blocks in FIG. 1, the flow from block G to block A indicates a loop, and an output of the system one time step before becomes an input of the system at the next time step.

In the case of realizing simulation on a multi-core or multiprocessor system, one processing unit is preferably assigned to one core or processor in order to perform parallel execution. In general, such parts in a model that can be independently processed are extracted and parallelized. In the example of FIG. 1, the processes of B, C−>E and D−>F can be independently processed after the processing A ends. Therefore cores or processors are assigned, for example, in the form of assigning one to the processing of B, one to the processing of A−>C−>E−>G, and one to the processing of D−>F. FIG. 2 shows an example of repeatedly performing calculation by this assignment.

As in FIG. 2, in repetition processing of such a model that a whole system is included in a loop, a result of the whole processing of one time step becomes an input for processing at the next time step, and therefore, the critical path of the model is the critical path of the repetition processing as it is. The example of FIG. 2 shows series processing in which, after the processing of block group 202 ends, the result is handed over to the next block group 204 and executed. The series arrangement of the processing of the path (A−>C−>E−>G) which requires the longest time among block groups 202, 204 and 206 becomes a critical path.

The method of speculatively performing parallel execution of processes corresponding to multiple time steps using multiple cores or processors is shown in FIG. 3. Theoretically, it is possible to obtain a high speed beyond the limit by the critical path in the processing shown in FIG. 2. The individual paths (B, A−>C−>E−>G, and D−>F) of block groups 302, 304 and 306 are assigned to separate processors and executed in parallel. It is seen that 3T required by the processing in FIG. 2 is shortened to T in FIG. 3. Such processing is described in the specification of Patent Application US20100106949.

However, in the parallel processing shown in FIG. 3, since processing is advanced in parallel without waiting for the end of processing of a previous time step, input prediction is performed. Therefore, in the case where the prediction significantly deviates, there is a possibility that the result of simulation may significantly deviate from a correct result if the processing is continued.

Accordingly, if the prediction is wrong, rollback processing for performing calculation again with a correct result as an input is performed in order to avoid the problem of significantly deviating from a correct result. However, since it is generally difficult to predict a strict value, a certain threshold is set, and rollback is not performed if a prediction error is within the range of the threshold. If rollback is performed in all cases where a predicted value does not strictly agree with a real value known afterwards, almost all the processes executed in parallel on the basis of prediction are generally performed again, and the parallelism is lost. Therefore, it is not possible to speed up simulation using this method.

Accordingly, it is necessary to allow a prediction error to some extent in order to secure parallelism by prediction. However, by allowing a prediction error, errors are accumulated with the progress of processing as shown in FIG. 4. Therefore, if an allowable error is set too high, large parallelism may be obtained, but the calculation result gradually deviates from a value actually thought to be correct and the simulation result may be not be accepted. In the parallel processing shown in FIG. 3, there is a tradeoff relationship between the amount of an allowable error and the speed of execution by parallelization, and as such, a method for obtaining both a decrease in the accumulation of errors and a higher execution speed is needed.

In the Japanese Published Unexamined Patent Application No. 2-226186, a method is disclosed for simulating change in a simulation target by performing an integration operation of a simultaneous differential equation system constituted by a group of multiple variables indicating temporal change in the simulation target with a predetermined time interval and sequentially repeating the integration operation using the values of the group of variables. A corrector is calculated, for a part of variables within the group of variables, with the use of the variables after the integration operation and the differential coefficients of the variables, and each variable value is corrected with the use of the corrector.

In “Speculative Decoupled Software Pipelining” by Neil Vachharajani, Ram Rangan, Easwaran Raman, Matthew J. Bridges, Guilherme Ottoni and David I. August, in Proceedings of the 16th International Conference on Parallel Architecture and Compilation Techniques, 2007, (hereinafter Vachharajani) a technique is disclosed for decomposing a processing loop into threads and speculatively executing the threads as software pipelining in a multi-core environment.

Published Unexamined Patent Application No. 2-226186 gives a general technique for correcting a resultant variable value in simulation. On the other hand, “Speculative Decoupled Software Pipelining” Vachharajani discloses speculative pipelining for a processing loop. However, Published Unexamined Patent Application No. 2-226186 does not suggest the application of pipelining in a multi-core environment.

Vachharajani provides a general scheme for speculative pipelining and a technique about propagation of an internal state between control blocks. However, it does not provide a technique for eliminating errors accumulated in the case of allowing an error for purposes of obtaining a higher execution speed.

### SUMMARY OF THE INVENTION

Accordingly, it is an object of the present invention to provide a technique for obtaining both a decrease in the accumulation of errors and a higher speed-up performance by calculating/correcting an output error based on a prediction error when increasing speed by speculatively parallelizing processing of multiple time steps in a multi-core or multiprocessor system.

According to one aspect of the present invention, a computer-implemented pipeline execution system is provided for executing loop processing in a multi-core or a multiprocessor computing environment, where the loop processing includes multiple function blocks in a multiple-stage pipeline manner. The system includes: a pipelining unit for pipelining the loop processing and assigning the loop processing to a computer processor or core; a calculating unit for calculating a first-order gradient term from a value calculated with the use of a predicted value of the input to a pipeline; and a correcting unit for correcting an output value of the pipeline with the value of the first-order gradient term.

According to another aspect of the present invention, a computer-implemented pipeline execution method is provided for executing loop processing in a multi-core or a multiprocessor computing environment, where the loop processing includes multiple function blocks in a multiple-stage pipeline manner. The method includes: pipelining the loop processing and assigning the loop processing to a computer processor or core; calculating a first-order gradient term from a value calculated with the use of a predicted value of the input to a pipeline; and correcting an output value of the pipeline with the value of the first-order gradient term.

According to yet another aspect of the present invention, a computer-implemented pipeline execution program product is provided for executing loop processing in a multi-core or a multiprocessor computing environment, where the loop processing includes multiple function blocks in a multiple-stage pipeline manner. The program product includes computer program instructions stored on a computer readable storage medium. When the instructions are executed, a computer will perform the steps of the method.

### BRIEF DESCRIPTION OF THE DRAWINGS

FIG. 1 is a diagram showing an example of function blocks including a loop;

FIG. 2 is a diagram showing an example of parallelization of the function blocks in FIG. 1;

FIG. 3 is a diagram showing an example of speculative pipelining of the function blocks in FIG. 1;

FIG. 4 is a diagram showing accumulation of differences between predicted values and actual values caused by execution of simulation;

FIG. 5 is a block diagram showing an example of hardware configuration according to embodiments of the present invention;

FIG. 6 is a diagram showing an example of function blocks including a loop;

FIG. 7 is a diagram showing an example of speculative pipelining of the function blocks in FIG. 6;

FIG. 8 is a diagram showing a block indicating a loop of function blocks in the form of a function according to embodiments of the present invention;

FIG. 9 is a diagram showing an example of speculative pipelining of the block in FIG. 8;

FIG. 10 is a diagram showing relationships among a predicted value, a calculated value and an actual value according to embodiments of the present invention;

FIG. 11 is a function block diagram of processing executed by speculative pipelining and accompanied by Jacobian matrix calculation according to embodiments of the present invention;

FIG. 12 is a diagram showing a flowchart of the processing executed by speculative pipelining and accompanied by Jacobian matrix calculation according to embodiments of the present invention;

FIG. 13 is a diagram showing a flowchart of Jacobian matrix calculation processing according to embodiments of the present invention;

FIG. 14 is a diagram showing a configuration for practicing the present invention in a system having a torus architecture according to embodiments of the present invention;

FIG. 15 is a diagram showing a parallel logical process according to embodiments of the present invention;

FIG. 16 is a diagram showing a flowchart of processing of a master process in the configuration in FIG. 14;

FIG. 17 is a diagram showing a flowchart of processing of a main process in the configuration in FIG. 14; and

FIG. 18 is a diagram showing a flowchart of processing of a Jacobian thread in the configuration in FIG. 14.

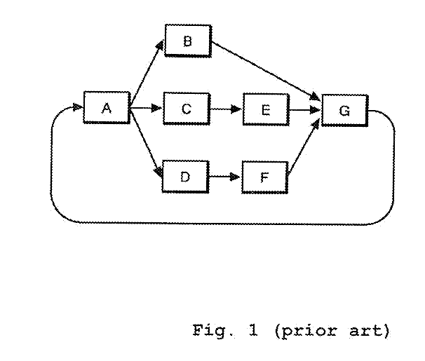

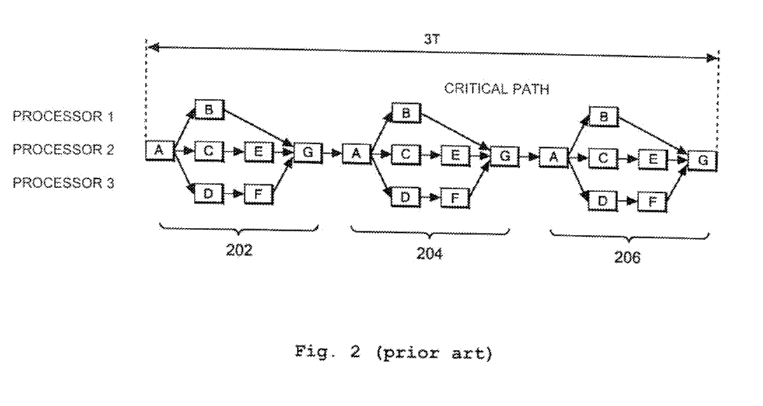

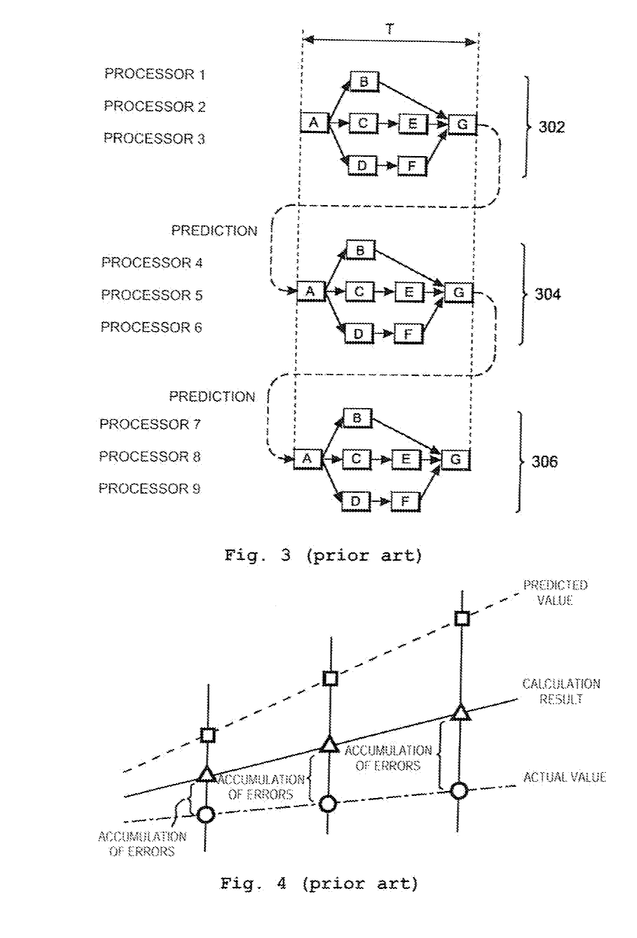

### DETAILED DESCRIPTION OF PREFERRED EMBODIMENTS

The configuration and processing of embodiments of the present invention will be described below with reference to drawings. In the description below, the same elements will be referred to by the same reference numerals throughout the drawings unless otherwise specified. It should be understood that the configuration and processing described here are described only as embodiments of the present invention and are not intended to limit the technical scope such described embodiments in the interpretation of the technical scope.

According to embodiments of the present invention, in a multi-core or multiprocessor system environment, processing of each time step by a control block written in MATLAB®/Simulink® or the like is preferably assigned to an individual core or processor as an individual thread or process by a speculative pipelining technique first.

Because of the nature of pipelining, a value obtained by predicting an output of the processing for the previous time step is given as an input to a thread or process being executed by a core or processor executing processing of the next time step. Any existing interpolation function, such as linear interpolation, Lagrange interpolation and least squares interpolation, can be used for this predicted input.

A value for a correction of the output based on the interpolated input is calculated based on the difference between the predicted input value and the output value of the previous time step (error of the prediction) and the approximation of the first-order gradient about predicted input of a simulation model.

Especially, in the case of a general simulation model, because there are multiple variables, a first-order gradient is indicated as a Jacobian matrix. Accordingly, in the embodiments of the present invention, such a matrix of which each element is a gradient value as an approximation of a first-order partial differential coefficient will be called a Jacobian matrix. Then, calculation of a correction value is performed by a Jacobian matrix defined in this way.

Calculation of a Jacobian matrix is assigned to a separate core or processor as a thread or process apart from calculation of the simulation body, and the execution time of the simulation body is not increased. By calculating a Jacobian matrix as an approximation of first-order gradients to correct an output value in a simulation system executed by speculative pipelining, the accuracy of simulation and the speed of simulation due to reduction in the frequency of rollback can be improved.

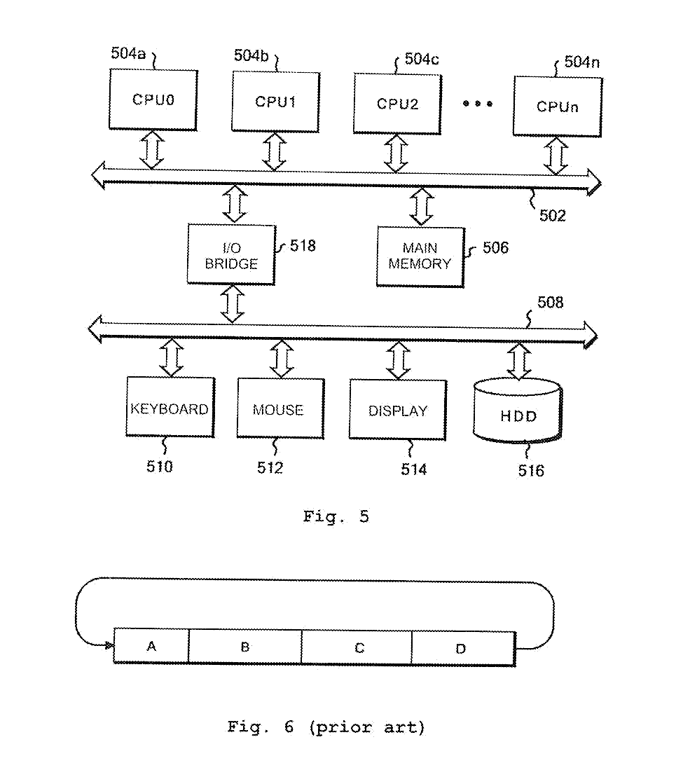

Referring to FIG. 5, a block diagram shows an example of the hardware of a computer to be used for implementing embodiments of the present invention. In FIG. 5, multiple CPUs, that is, CPU1 504a, CPU2 504b, CPU3 504c, . . . , CPUn 504n are connected to a host bus 502. A main memory 506 for operation processing by the CPU1 504a, CPU2 504b, CPU3 504c, . . . , CPUn 504n is further connected to the host bus 502. A typical example of such configuration is a symmetric multiprocessing (SMP) architecture.

On the other hand, a keyboard 510, a mouse 512, a display 514 and a hard disk drive 516 are connected to an I/O bus 508. The I/O bus 508 is connected to the host bus 502 via an I/O bridge 518. The keyboard 510 and the mouse 512 are used by an operator to perform an operation by typing a command or a clicking a menu item. The display 514 is used to display a menu for operating a program according to the present invention, which is to be described later, with a GUI as necessary.

As an example of the hardware of a preferable computer system used for this purpose, IBM® System X is given. In this case, the CPU1 504a, CPU2 504b, CPU3 504c, . . . , CPUn 504n are, for example, Intel® Xeon®, and the operating system is Windows® (trademark) Sever 2003. The operating system is stored in the hard disk drive 516, and it is read into the main memory 506 from the hard disk drive 516 when the computer system is activated.

It is necessary to use a multiprocessor system to practice the embodiments of the present invention. Here, the multiprocessor system is generally intended to be a system using a processor having multiple processor function cores capable of independently performing operation processing; it can be a multi-core single-processor system, a single-core multiprocessor system, or a multi-core multiprocessor system.

The hardware of the computer system, which can be used to practice the embodiments of the present invention, is not limited to IBM® System X. Any computer system can be used if the simulation program of the embodiments of the present invention can be run thereon. The operating system is not limited to Windows®, either. Any operating system, such as Linux® and Mac OS®, can be used. Furthermore, a computer system, such as POWER (trademark) 6 based IBM® System P with the operating system of AIX (trademark), can be used to cause the simulation program to operate at a high speed. Furthermore, the Blue Gene® Solution available from International Business Machines Corporation can be used as the hardware of a computer system that supports the embodiments of the present invention.

Further stored in the hard disk drive 516 are the MATLAB®/Simulink®, a C compiler or a C++ compiler, a module for analysis, flattening, clustering and development, a CPU assignment code generation module, a module for measuring an expected execution time of a processing block, and the like, which will be described later. These items are loaded onto the main memory 506 and executed in response to a keyboard or mouse operation by an operator.

A usable simulation modeling tool is not limited to MATLAB®/Simulink®. Any simulation modeling tool, such as an open-source tool, Scilab/Scicos, can be used.

It is also possible to directly write the source code of a simulation system in C, C++ or the like without using a simulation modeling tool in some cases. In such cases also, the embodiments of the present invention is applicable if individual functions can be described as individual function blocks that are in dependence relationships with one another.

FIGS. 6 and 7 are diagrams illustrating the speculative pipelining technique disclosed by Vachharajani. FIG. 6 is a diagram showing an illustrative Simulink® loop configured by function blocks A, B, C and D.

The loop of the function blocks A, B, C and D is assigned to the CPU1, the CPU2 and the CPU3 by the speculative pipelining technique as shown in FIG. 7. That is, the CPU1 sequentially executes function blocks Aₖ₋₁, Bₖ₋₁, Cₖ₋₁ and Dₖ₋₁ by one thread; the CPU2 sequentially executes function blocks Aₖ, Bₖ, Cₖ and Dₖ by another thread; and the CPU3 sequentially executes function blocks Aₖ₊₁, Bₖ₊₁, Cₖ₊₁ and Dₖ₊₁ by still another thread.

The CPU2 speculatively starts processing with a predicted input without waiting for the CPU1 to complete Dₖ₋₁. The CPU3 speculatively starts processing with a predicted input without waiting for the CPU2 to complete Dₖ. By such speculative pipelining processing, the whole processing speed is improved.

Vachharajani discloses that the internal states of function blocks are propagated from the CPU1 to the CPU2, and from the CPU2 to the CPU3. In general, a function block may have an internal state in a simulation model by Simulink® or the like. This internal state is updated by processing a certain time step, and the value is used by processing the next time step. Therefore, in the case of speculatively parallelizing and executing processes of multiple time steps, prediction of the internal states is also required. However, by handing over the internal states in pipelining manner, the necessity of the prediction is eliminated, as in Vachharajani. For example, an internal state x_{A}(tₖ) of Aₖ₋₁ executed by the CPU1 is propagated to the CPU2 which executes the function block Aₖ and used by the CPU2. Thus, the speculative pipelining technique does not require prediction of an internal state.

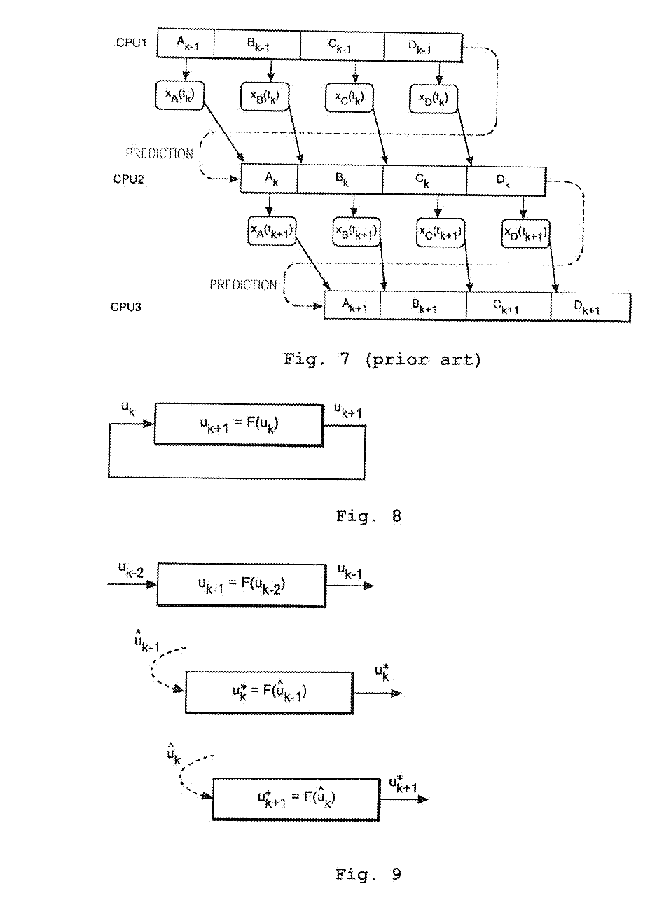

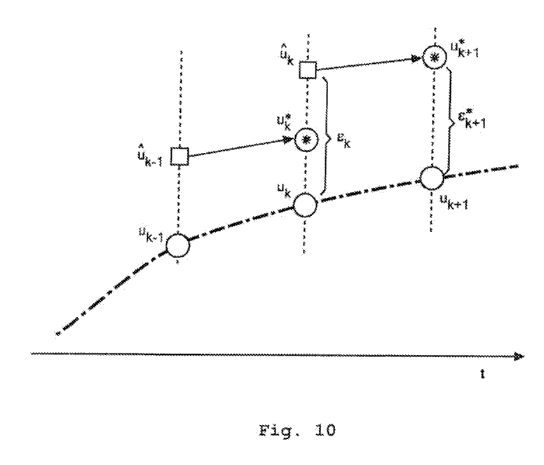

FIG. 8 is a diagram in which the function block loop as shown in FIG. 6 is indicated as a function. That is, uₖ is inputted, and uₖ₊₁ obtained as a result of processing of uₖ₊₁=F(uₖ) is outputted.

In uₖ₊₁=F(uₖ), the analytically indicated function F(uₖ) does not necessarily exist. In short, when a function block is executed with an input of uₖ, uₖ₊₁ is outputted as a result of the processing.

Furthermore, both uₖ and F(uₖ) are actually vectors and are indicated as follows:

uₖ=(u₁(tₖ), . . . , uₙ(tₖ))^{T}; and

F(uₖ)=(f₁(uₖ), . . . , fₙ(uₖ))^{T}

FIG. 9 is a diagram showing the case of performing speculative pipelining processing of the loop in FIG. 8. In FIG. 9, processing of uₖ₋₁=F(uₖ₋₂) is outputted by one CPU at the first stage, and a result of u^{*}ₖ=F(ûₖ₋₁) is calculated and outputted by another CPU at the second stage. The input to the second stage is not uₖ₋₁ , the result of the processing at the first stage, but a predicted input ûₖ₋₁ . That is, because waiting for the processing of the first stage to end decreases the speed, the input ûₖ₋₁ predicted from the previous stage is prepared and inputted to the second stage so that the processes are parallelized and sped up.

Similarly, the input to the third stage is not *uₖ, the result of the calculation of the second stage, but a predicted input ûₖ, and u*ₖ₊₁=F(ûₖ) is calculated and outputted as a result.

In the description below, the expression ûwill be identified with the following:

Formula 1

û

If prediction is successful, the operation speed of simulation can be improved by such speculative pipelining. However, if there is an intolerable error between the predicted input ûₖ and the actual input uₖ, the operation speed is not improved because the stage that calculated uₖ₊₁ has to be done again with a correct input. In general, it is difficult to predict an exact input. Therefore, by regarding prediction as having succeeded if a prediction error is below a certain threshold and adopting a calculation result as it is, speed-up is obtained for a lot of simulation models. In this case, a problem occurs that allowed errors are gradually accumulated. FIG. 10 shows a typical scenario.

In FIG. 10, although u*ₖ is calculated from ûₖ₋₁, this u*ₖ is not used for calculation at the next stage. The next stage starts with a new predicted input ûₖ, and the calculation result is u*ₖ₊₁.

The difference between a predicted value and a nominal value is denoted as εk=û^{k}−uk, and the difference between a calculated value and the nominal value is denoted as ε*ₖ=u*ₖ−uₖ. There is a possibility that the error ε*ₖ gradually increases with the progress in time of the simulation as seen from FIG. 10. If errors accumulate in this way, the result of simulation may not be accepted.

As described above, an object of the present invention is to suppress the accumulated errors. Such errors can be eliminated by adding a correction obtained by a predetermined calculation to an output obtained from the configurations shown in FIGS. 8 and 9. The algorithm will be described below.

First, the Taylor expansion of the vector function F(uₖ) around uₖ=ûₖ is as follows:

F(uₖ)=F(ûₖ)−J_{f}(ûₖ)εₖ+R(|εₖ|²)

Here, J_{f}(ûₖ) is a Jacobian matrix, and it is indicated by a formula as shown below:

$${J}_{f} ( {u}_{k}^{\hat{}} ) = ( \begin{matrix}\frac{\partial {f}_{1} ( {u}_{k}^{\hat{}} )}{\partial {u}_{1}} & ⋯ & \frac{\partial {f}_{1} ( {u}_{k}^{\hat{}} )}{\partial {u}_{n}} \\ ⋮ & ⋱ & ⋮ \\ \frac{\partial {f}_{n} ( {u}_{k}^{\hat{}} )}{\partial {u}_{1}} & ⋯ & \frac{\partial {f}_{n} ( {u}_{k}^{\hat{}} )}{\partial {u}_{n}}\end{matrix} ) \qquad Formula 2$$

R(|εₖ|²) indicates a quadratic or higher term of the Taylor expansion.

In the case where the prediction accuracy is high, all the elements of εₖ is such a vector that all the elements are small real numbers. When εₖ is small, the quadratic or higher term of the Taylor expansion is also small and, therefore, R(|εₖ|²) can be ignored. When εₖ is large, R(|εₖ|²) cannot be ignored, and correction calculation cannot be executed. In such a case, calculation that is done with predicted input is redone with the correct input that is the actual output of the computation for the previous time step. In this case, whether Eₖ is sufficiently small or not is determined on the basis of a threshold given in advance.

Because ε*ₖ₊₁=F(ûₖ)−F(uₖ), ε*ₖ₊₁ almost equals to J_{f}(ûₖ)εₖ if R(|εₖ|²) can be ignored, by using εₖ=ûₖ−uₖ and ε*ₖ=u*ₖ-uₖ, ε*ₖ₊₁ can be approximated with J_{f}(ûₖ)(ûₖ−uₖ).

However, F(uₖ)=(f₁(uₖ), . . . , fₙ(uₖ))^{T} is not necessarily analytically partially differentiable for uₖ=(u₁(tₖ), . . . , uₙ(tₖ))^{T}. Therefore, it is not necessarily possible to analytically determine the above Jacobian matrix.

Accordingly, in embodiments of the present invention, approximation of the Jacobian matrix is performed by a difference formula as shown below:

$$\begin{matrix}{J}_{f} ( {u}_{k}^{\hat{}} ) \approx {( \frac{F ( {u}_{k}^{\hat{}} + {H}_{1} ) - F ( {u}_{k}^{\hat{}} )}{{h}_{1}} ⋯ \frac{F ( {u}_{k}^{\hat{}} + {H}_{n} ) - F ( {u}_{k}^{\hat{}} )}{{h}_{n}} )}^{T} \\ = {J}_{f}^{\hat{}} ( {u}_{k}^{\hat{}} )\end{matrix} \qquad Formula 3$$

Here, Hᵢ=(0 . . . 0 hᵢ 0 . . . 0)^{T}. That is, this is a matrix in which the i-th element from the left end is hᵢ, and the other elements are 0. Furthermore, hᵢ is a suitable small scalar value.

By using the approximated Jacobian matrix Ĵ_{f}(ûₖ), ε*ₖ₊₁=Ĵ_{f}(ûₖ)(ûₖuₖ) can be calculated. Furthermore, by using ε*ₖ₊₁, a corrected value uₖ₊₁ is obtained by Uₖ₊₁=u*ₖ₊₁-ε*ₖ₊₁. Decreasing the accumulation of errors can be accomplished by the calculation as described above.

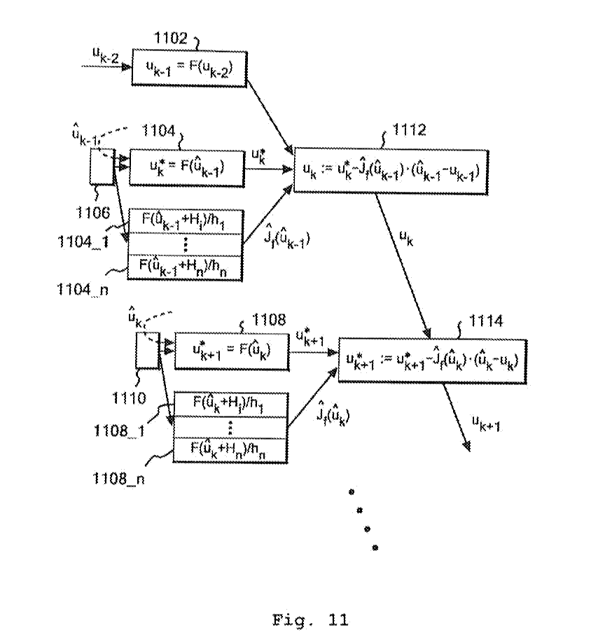

Next, the configuration of a system for performing the error correction function described above in speculative pipelining in accordance with embodiments of the present invention is described with reference to FIG. 11.

First, uₖ₋₂ is inputted to block 1102 assigned to the CPU1, and block 1102 outputs uₖ₋₁=F(uₖ₋₂). In parallel with this, a predicted value ûₖ₋₁ is inputted to block 1104 assigned to the CPU2, and block 1104 outputs u*ₖ=F(ûₖ₋₁). Calculation of the predicted value is performed at block 1106, for example, by a method as described below.

One method is a linear interpolation, which is indicated by a formula as described below:

ûᵢ(tₖ₊ₘ₊ⱼ)=m·uᵢ(tₖ₊ⱼ₊₁)−(m−1)·uᵢ(tₖ₊ⱼ)

Another method is Lagrange interpolation, which is indicated by a formula as described below:

$${u}_{i}^{\hat{}} ( {t}_{k + m + j} ) = {\sum }_{a = k + m - 1}^{k + m} {u}_{i} ( {t}_{a} ) {L}_{a} ( {t}_{k + m + j} ) \\ {L}_{a} ( {t}_{k + m + 1} ) = {\prod }_{b = k + m - 1 , b \neq a}^{k + m} \frac{{t}_{k + m + j} - {t}_{b}}{{t}_{a} - {t}_{b}} \qquad Formula 4$$

The method for calculating a predicted value is not limited thereto, and any interpolation method, such as least squares interpolation, can be used. If there is a sufficient number of CPUs, the processing performed at block 1106 may be separately assigned to a CPU different from the CPU to which block 1104 is assigned as a different thread. Otherwise, the processing may be performed by the CPU to which block 1104 is assigned.

In this embodiment, auxiliary threads 1104_{—}1 to 1104_n for calculating the components of a Jacobian matrix are separately activated. That is, F(ûₖ₋₁+H₁)/h₁ is calculated by the auxiliary thread 1104_{—}1, and F(ûₖ₋₁+Hₙ)/hₙ is calculated by the auxiliary thread 1104_n. If there is a sufficient number of CPUs, such auxiliary threads 1104_{—}1 to 1104_n are individually assigned to CPUs different from the CPU to which block 1104 is assigned and can execute the original calculation without delay.

If there is not a sufficient number of CPUs, the auxiliary threads 1104_{—}1 to 1104_n may be assigned to the same CPU that block 1104 is assigned to.

At block 1112, uₖ is calculated from the formula of uₖ=u*ₖ-Ĵ_{f}(ûₖ₋₁)(ûₖ₋₁-uₖ₋₁) with the use of uₖ₋₁ from block 1102, u*ₖ from block 1104, and F(ûₖ₋₁+H₁)/h₁, F(ûₖ₋₁+H₂)/h₂, . . . , F(ûk₋₁+Hₙ)/hₙ, that is, Ĵ_{f}(ûₖ₋₁) from the auxiliary threads 1104_1 to 1104_n.

In parallel with this, to block 1108 assigned to CPU3, a predicted value ûₖ is inputted from block 1110 by an algorithm similar to that of block 1106, and block 1108 outputs u*ₖ₊₁=F(uₖ). If there is a sufficient number of CPUs, the processing performed at block 1110 may be separately assigned to a CPU different from the CPU to which block 1108 is assigned as a different thread. Otherwise, the processing may be performed by the CPU to which block 1108 is assigned.

Similar to the case of block 1104, auxiliary threads 1108_{—}1 to 1108_n for calculating the components of a Jacobian matrix are separately activated and associated with block 1108. Since the subsequent processing is similar to the case of block 1104 and the auxiliary threads 1104_{—}1 to 1104_n, a description will not be repeated. However, block 1114 receives uₖ from block 1112 to calculate a correction value ε*ₖ₊₁. As for block 1114 and the subsequent corrections, calculations are performed in a similar manner.

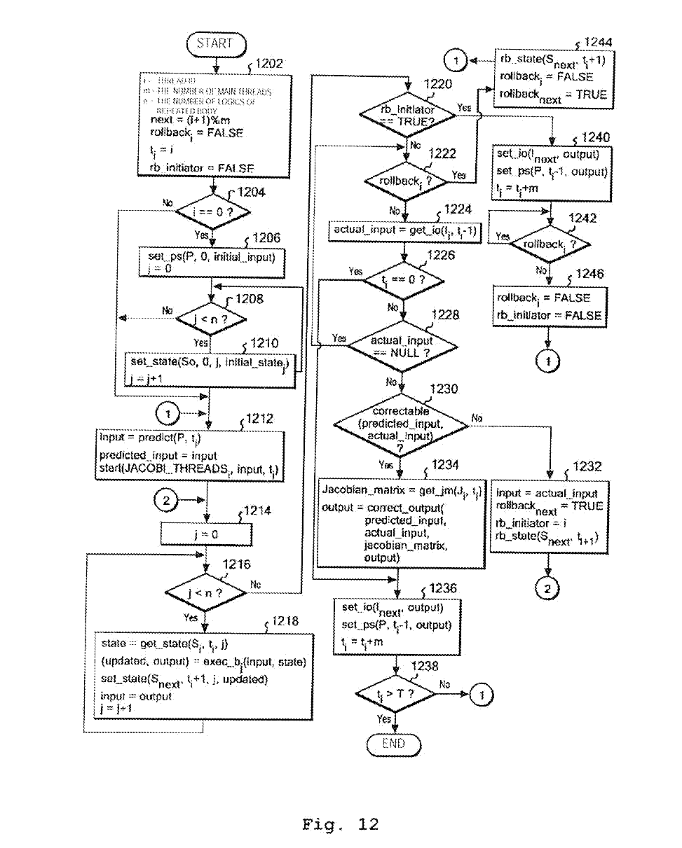

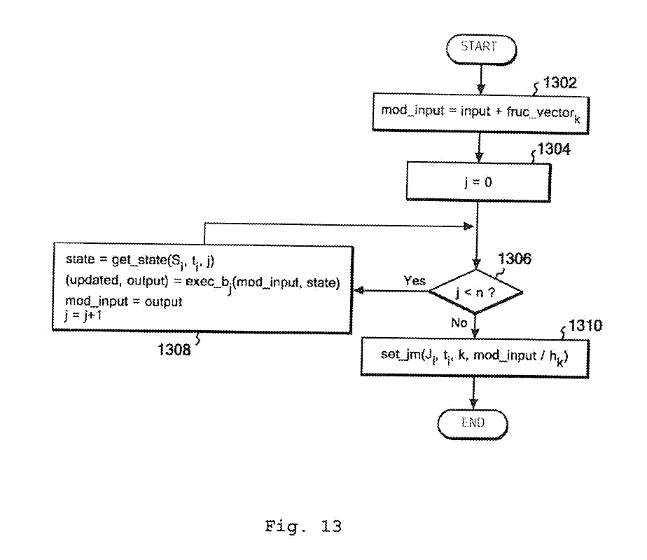

FIG. 12 is a flowchart showing the operation of a thread (main thread) which executes the processing of the simulation body of this embodiment of the present invention.

At the first step 1202, the variables used for the processing by the thread are initialized. First, a thread ID is set for i. Here, it is assumed that the thread ID is incremented in a manner that the thread ID of the thread of the first stage of pipelining is 0 and the thread ID of the next stage is 1. The number of main threads is set for m. Here, the main thread refers to a thread which executes the processing of each stage of pipelining. The number of logics is set for n. Here, the logic refers to one of the parts obtained by dividing the whole processing of a simulation model. By sequentially arranging the logics, processing corresponding to one time step which is repeatedly executed by a main thread is provided. In the example in FIG. 6, each of A, B, C and D is one logic.

In a variable next, (i+1)% m, that is, a remainder obtained by dividing (i+1) by m is stored. This becomes the ID of a thread in charge of processing of the next time step following the i-th main thread.

For tᵢ, i is set. The tᵢ indicates the time step of processing to be executed by the i-th thread. At step 1202, the i-th thread is to start processing at a time step tᵢ.

Furthermore, FALSE is set for rollbackᵢ and rb_initiator. These are variables for executing rollback processing, which is to be performed in the case where correction cannot be executed because the prediction error is too high, throughout multiple main threads.

At step 1204, whether i is 0 or not is checked is determined, that is, whether the thread is the first (zeroth) thread or not. If the thread is the first thread, a function set_ps(P, 0, initial_input) is called at step 1206 in order to start processing with an initial input as an input. Here, initial_input refers to an initial input (vector) of the simulation model. P is a buffer for holding an input point at a past time step (a pair of time step and input vector) to be used for prediction of an input at a future time step. A function set_ps(P, t, input) performs an operation of recording input in P as an input at a time step t, that is, a pair of the time step 0 and the initial input is set for P by set_ps(P, 0, initial_input). The value recorded here will be an input to the first logic executed by the thread later. Furthermore, j=0 is set.

Next, at steps 1208 and 1210, the (initial) internal state of each logic required for the zeroth thread to execute processing schedule for the time step 0 is enabled so that it can be used by the thread.

At step 1210, a function set_state(S₀, 0, j, initial_stateⱼ) is called. Here, S₀ is a buffer for holding the internal state used by each logic of the zeroth thread (i-th thread in the case of Sᵢ). Internal states are recorded in the form that data indicating one internal state corresponds to a pair of numerical values indicating a time step and a logic ID.

By calling set_state(S₀, 0, j, initial_stateⱼ), an (initial) internal state initial_stateⱼ is recorded in S₀ in the form corresponding to a pair of a logic ID j and the time step 0 (j, 0). The (initial) internal state recorded here is to be used at a stage where the zeroth thread executes each logic later.

By j being incremented by one and from the determination at step 1208, step 1210 is repeated until j reaches n. When j reaches n, the flow proceeds to step 1212 on the basis of the determination at step 1208.

If i is not 0, an input value at the time step tᵢ (that is, an output value of processing at time step tᵢ₋₁) has not been obtained at the time point of step 1202 because the thread is not the first thread. Therefore, the flow directly proceeds to step 1212.

At step 1212, a function predict(P, tᵢ) is called, and the result is substituted for input. The function predict(P, tᵢ) predicts an input vector of processing of the time step tᵢ and returns the predicted input vector.

As a prediction algorithm used in this case, linear interpolation, Lagrange interpolation or the like is applied with the use of vector data accumulated in P, as described before. However, if vector data for the time step tᵢ is already recorded in P, the vector data is returned. In the example in FIG. 11, execution is performed by blocks 1106, 1110 and the like. There may be a case where points (pairs of time step and input vector) enough to execute prediction are not held in P immediately after start. In this case, a waiting process occurs until necessary points are given to P. That is, a waiting process occurs until the thread in charge of a previous time step ends processing. The vector data obtained in this way by calling predict(P, tᵢ) is stored in a variable predicted_input.

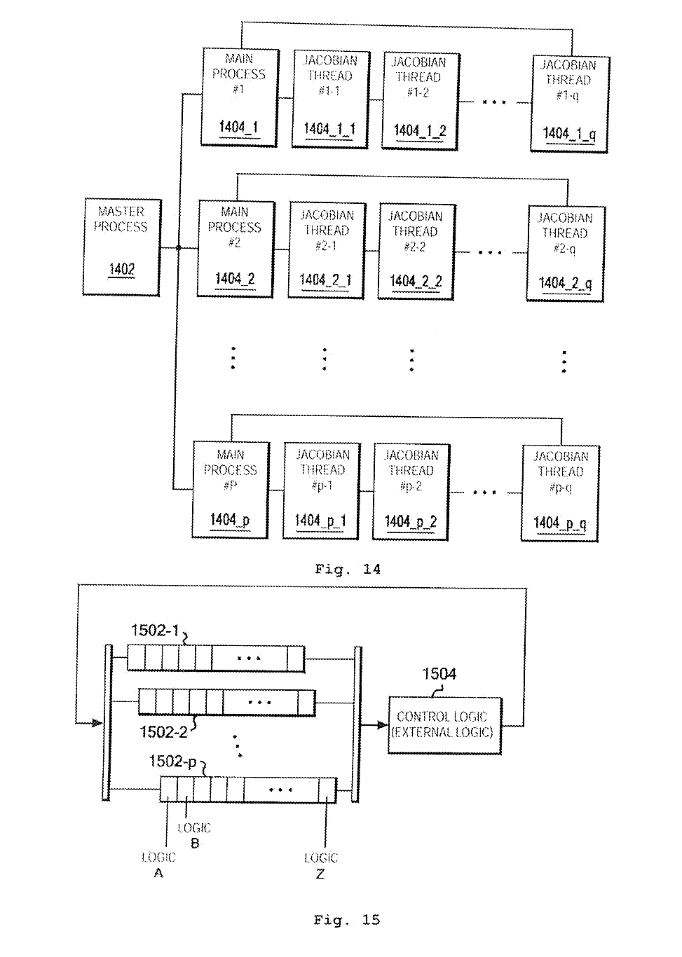

Next, at this step, start(JACOBI_THREADSi, input, tᵢ) is called to start a thread for calculating a Jacobian matrix to be used by the thread. Processing the thread for calculating a Jacobian matrix started here is shown in FIG. 13, and the contents thereof will be described later.

At the next steps 1214, 1216 and 1218, logics are sequentially executed. When all the logics have been executed, processing for proceeding to the next step 1220 is performed. That is, j is set to 0 at step 1214, and it is determined at step 1216 whether j is smaller than n. Then, step 1218 is executed until j reaches n on the basis of the determination at step 1216.

At step 1218, one logic is executed. First, get_state(Sᵢ, tᵢ, j) is called there first. This function returns vector data (internal state data) recorded in association with a pair of (tᵢ, j) into Sᵢ. However, if there is no such data or if a flag is set for the data associated with the pair of (tᵢ, j), waiting occurs until the data for the pair of (tᵢ, j) is recorded in Sᵢ or until the flag is released. The result returned from get_state(Sᵢ, tᵢ, j) is stored in a variable state.

Next, at this step, exec_bⱼ(input, state) is called. When the j-th logic is assumed to be bⱼ, this function executes its processing with an input to bⱼ as input and the internal state to bⱼ as state. As a result thereof, a pair of an internal state at the next time step (updated) and an output of bⱼ (output) is returned as the result.

The returned updated is used as an argument for calling the next set_state(Sₙₑₓₜ, tᵢ+1, j, updated). By this calling, the internal state is recorded into Sₙₑₓₜ in the form that updated is associated with a pair of (tᵢ+1, j). In this case, if vector data for the pair of (tᵢ+1, j) already exists, the vector data is overwritten with updated, and a set flag is released. This processing makes it possible to refer to and use a necessary internal state when the next-th thread executes each logic.

Next, at this step, output is substituted for input. This becomes an input to bⱼ₊₁ Then, j is incremented by one, and the flow returns to step 1216. In this way, step 1218 is repeated until j reaches n. When j equals to n, the flow proceeds to the next step 1220.

Step 1220 and the succeeding steps are part of the stage for correcting a calculated value on the basis of a predicted input. As described before, rollback processing is performed in the case where the prediction error that is too high.

At step 1220, a determination is made as to whether rb_initiator is TRUE or not. If rb_initiator is TRUE, it indicates that the thread has activated rollback processing before, and the rollback processing is being performed. On the other hand, if rb_initiator is FALSE, it indicates that the thread has not activated rollback processing, and rollback processing is not being performed. In a normal flow of executing correction, rb_initiator is FALSE. If it is determined at this step that rb_initiator is FALSE, the flow proceeds to step 1222.

At step 1222, a determination is made as to whether the value of rollbackᵢ is TRUE or not. If the value of rollbackᵢ is TRUE, it indicates that rollback processing has been activated by a thread before the thread and the thread has to execute processing required for rollback. On the other hand, if the value of rollbackᵢ is FALSE, it indicates that the thread does not have to execute the processing required for rollback. In a normal flow of executing correction, rollbackᵢ is FALSE. If it is determined at this step that rollbackᵢ is FALSE, the flow proceeds to step 1224.

At step 1224, get_io(lᵢ, tᵢ−1) is called. Here, lᵢ is a buffer for holding an input to the top logic to be used by the i-th thread. Only one pair of time step and input vector is recorded in this buffer. The input vector recorded in lᵢ is returned by get_io(lᵢ, tᵢ−1). However, if a given time step (tᵢ−1) does not agree with the time step recorded being paired with the input vector or if the data does not exist, NULL is returned.

Next, at step 1226, a determination is made as to whether tᵢ is 0 or not. This is a step for avoiding an infinite loop at step 1228, which is involves waiting until an output result of the previous time step is obtained for correction calculation, because an output time step before tᵢ does not exist if tᵢ is 0 and actual_input is necessarily NULL at step 1228. If tᵢ is 0, the step for correction calculation and the like is not performed, and the flow directly proceeds to step 1236. If tᵢ is not 0, the flow proceeds to step 1228.

At step 1228, a determination is made as to whether actual_input is NULL or not. If actual_input is NULL, it indicates that an output of processing the previous time step has not been obtained yet—that is, waiting until an output result of processing schedule for the previous time step required for correction calculation is obtained, as described before. If the necessary output has not been obtained, the flow returns to step 1222. If the necessary output has been obtained, actual_input is not NULL, and, therefore, the flow proceeds to step 1230.

At step 1230, correctable(predicted_input, actual_input) is called. This function returns FALSE if Euclidean norms of predicted_input and actual_input, which are vectors with the same number of elements, exceed a predetermined threshold. Otherwise, it returns TRUE. If correctable(predicted_input, actual_input) returns FALSE, it indicates that a prediction error is too large to perform correction processing. If TRUE is returned, it indicates that correction is possible. If correction is possible, the flow proceeds to step 1234.

At step 1234, get_jm(Jᵢ, tᵢ) is called first. Here, Jᵢ is a buffer for holding a Jacobian matrix to be used by the i-th thread, and each column vector of the Jacobian matrix is recorded in the form of being paired with a value of a time step.

The function get_jm(Jᵢ, tᵢ) is a function for returning the Jacobian matrix recorded in Jᵢ. It returns the Jacobian matrix after it waits until all time step data recorded being paired with the column vectors of the Jacobian matrix is equal to a given argument tᵢ.

The Jacobian matrix obtained in this way is set as a variable jacobian_matrix. Next, correct_output(predicted_input, actual_input, jacobian_matrix, output) is called. In short, this function corresponds to calculation executed at block 1112 or 1114 in FIG. 11.

When block 1114 is taken as an example, predicted_input corresponds to ûₖ; actual_input corresponds to uk; jacobian_matrix corresponds to Ĵf(ûₖ); and output corresponds to u*ₖ₊₁. The return value of this function is uₖ₊₁. At this step, a corrected output obtained as a result of correct_output(predicted_input, actual_input, jacobian_matrix, output) is stored in output.

After that, the flow proceeds to step 1236, and set_io(lₙₑₓₜ, tᵢ, output) is called first. This function overwrites data which is already recorded in lₙₑₓₜ with a pair of time step tᵢ and output. This is used by the next-th thread to calculate the predicted error of the thread and perform output correction.

Next, at this step, set_ps(P, tᵢ₊₁, output) is called. Thereby, output is recorded into P as input data of time step tᵢ₊₁. Next, tᵢ is increased by m, and the processing proceeds to determination at step 1238.

At step 1238, whether tᵢ>T is satisfied or not is determined. Here, T is a value indicating the length of the time series of the behavior of the system, which is outputted by the simulation being executed.

If tᵢ exceeds T, the processing of the thread is ended because the behavior of the system at time steps after that is unnecessary. If tᵢ does not exceed T, the flow returns to step 1212, and processing of the time step when the thread is to execute processing next is performed. If correctable(predicted_input, actual_input) returns FALSE at step 1230, the flow proceeds to step 1232, where preparation for performing rollback is performed.

At step 1232, actual_input is set for input; TRUE is set for rollbackₙₑₓₜ; TRUE is set for rb_initiator; and rb_state(Sₙₑₓₜ, tᵢ+1) is called. By rollbackₙₑₓₜ being set to TRUE, it is possible to propagate that the processing of a time step which is being executed currently must be performed again by the next-th thread.

In the function rb_state(Sₙₑₓₜ, tᵢ+1), a flag indicating that vector data recorded in Snext in association with (tᵢ1, k) is ineffective is set for the vector data. In this case, k=0, . . . , n−1. This indicates that the internal state calculated by each logic is ineffective, and the internal state for which the flag is set is not used by a logic on the next-th main thread. Thereby, the logic on the main thread has to wait to execute calculation until rollback is completed and a correct internal state is given to Sₙₑₓₜ, so that calculation is prevented from progressing on the basis of a wrong value.

After that, by returning to step 1214, the processing of the same time step is performed again with the use of vector data, which is the result of processing of the previous time step, as an input. When the processing of the same time step is re-performed via steps 1214, 1216 and 1218, rb_initiator is necessarily determined to be TRUE when the flow proceeds to step 1220. In this case, the flow proceeds to step 1240, where the recalculated output is propagated to the next-th thread by calling set_io(lₙₑₓₜ, tᵢ, output), and set_ps(P, tᵢ+1, output) is called to update data to be used for prediction.

After that, the flow proceeds to step 1242. At step 1242, waiting is performed until rollbackᵢ becomes TRUE. This variable rollbackᵢ is changed to FALSE by a thread immediately before the thread behaving as described below, and it is possible to exit the loop.

First, by setting rollbackₙₑₓₜ to TRUE at step 1232 in the thread, the processing branches to step 1244, at step 1222 of the next-th thread.

At step 1244 of the thread, rb_state(Sₙₑₓₜ, tᵢ+1) is called, and rollbackᵢ is set to FALSE and rollbackₙₑₓₜ is set to TRUE after making the internal state ineffective as described before. Thereby, similar re-performance processing (rollback) can be further propagated to the next thread. By repeating this in turn, the rollback flag (rollbackᵢ) of the thread which activated the rollback processing becomes TRUE finally. Thereby, the thread exits from the loop of step 1242 and proceeds to step 1246. Here, rollbackᵢ is set to FALSE; the flag rb_initiator indicating that the thread is a thread which activated rollback processing is set to FALSE; and the flow proceeds to normal logic processing 1212 based on prediction.

Processing executed by start(JACOBI_THREADSᵢ, input, tᵢ) at step 1208 in FIG. 12 will be described in detail.

JACOBI_THREADSᵢ indicates multiple threads. FIG. 13 shows a flowchart indicating processing of the k-th thread.

At step 1302, the operation of mod_input=input+fruc_vectorₖ is performed. Here, fruc_vectorₖ is such column vector data that the vector size is equal to the number of elements of an input vector of the top logic of the model, the k-th element is hₖ, and all the other elements are 0. This is the same as what was described with regard to FIG. 11 on the assumption of Hᵢ=(0 . . . 0 hᵢ 0 . . . 0)T, in which i is changed to k. In this processing, an input value, for which only one component of the input vector is slightly displaced, is created to calculate a Jacobian matrix.

At step 1304, j is set to 0 once. After that, step 1308 is repeated until j is determined to have reached n by a determination step 1306. Here, n is the number of logics included in the model set at step 1206 in FIG. 12, and the whole of the logics is executed simply with mod_input as an input.

At step 1308, get_state(Sᵢ, tᵢ, j) is called first. The processing of get_state(Sᵢ, tᵢ, j) is identical to the processing of the function with the same name called in FIG. 12. The result is set in a variable state. Also in the same step, exec_bⱼ(mod_input, state) is called next. The processing of exec_bj(mod_input, state) is identical to the processing of the function with the same name called in FIG. 12, and processing of one logic is executed. Output obtained as a result of execution of exec_bⱼ(mod_input, state) is set for mod_inout next; j is incremented by one; and the flow returns to step 1306. Thereby, the processing proceeds to the next logic. When j=n is satisfied by repeating step 1308, the processing of all the logics ends. The flow goes to step 1310, where set_jm(Jᵢ, tᵢ, k, mod_input/hₖ) is called.

The function set_jm(Jᵢ, tᵢ, k, mod_input/hₖ) records mod_input/hₖ into Jᵢ as a vector element of the k-th column of the Jacobian matrix in association with the time step tᵢ. In this case, data already recorded in Jᵢ is overwritten.

After step 1310, the processing shown by the flowchart in FIG. 13 ends. All the threads of k=0, . . . , n−1 end; a Jacobian matrix corresponding to the time step tᵢ is completed.

FIG. 14 is a diagram showing that the present invention is practiced by a computer system having an architecture in which nodes are three-dimensionally connected like a torus. The Blue Gene® Solution from International Business Machines Corporation is an example of a computer system having such an architecture, although embodiments of the present invention are not limited to the use of such a computer system.

In FIG. 14, a master process managing the whole operation processing is assigned to a node 1402. Nodes 1404_1, 1404_2, . . . , 1404_p are associated with the node 1402, and main processes #1, #2, . . . #p are assigned thereto, respectively. Processes assigned to the main processes #1, #2, . . . , #p are logically equivalent to the processes indicated by blocks 1102, 1104 and 1108 in FIG. 11.

A series of nodes 1404_1_1, 1404_1_2, . . . , 1404_1_q are associated with the node 1404_1. Jacobian threads #1-1, #1-2, . . . , #1-q are assigned to the nodes 1404_1_1, 1404_1_2, . . . , 1404_1_q. Processes assigned to the Jacobian threads #1-1, #1-2, . . . , #1-q are logically equivalent to the processes indicated by blocks 1104_1 to 1104_n in FIG. 11.

A series of nodes 1404_2_1, 1404_2_2, . . . , 1404_2_q are associated with the node 1404_2. Jacobian threads #2-1, #2-2, . . . , #2-q are assigned to the nodes 1404_2_1, 1404_2_2, . . . , 1404_2_q.

Similarly, a series of nodes 1404_p_1, 1404_p_2, . . . , 1404_p_q are associated with the node 1404_p. Jacobian threads #p-1, #p-2, . . . , #p-q are assigned to the nodes 1404_p_1, 1404_p_2, . . . , 1404_p_q.

FIG. 15 is a diagram schematically showing a process executed on the system in FIG. 14. Pipelining processes 1502_1, 1502_2, . . . , 1502_p are processes assigned to the nodes 1404_1, 1404_2, . . . , 1404_p, respectively, and each of them are constituted by logics A, B, . . . , Z. The logics A, B, . . . , Z are equal to the function blocks indicated as blocks A, B, C and D in FIG. 6. The series of Jacobian threads, which are auxiliary threads, are not shown in FIG. 15.

In FIG. 15, a control logic (external logic) 1504 generically indicates other processes in the simulation system. For example, there may be a case where Simulink operates in cooperation with an external program, and the control logic 1504 refers to the external program.

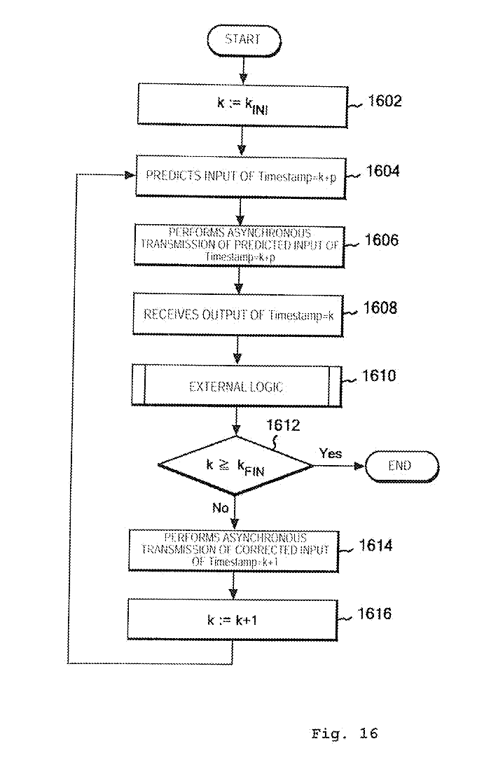

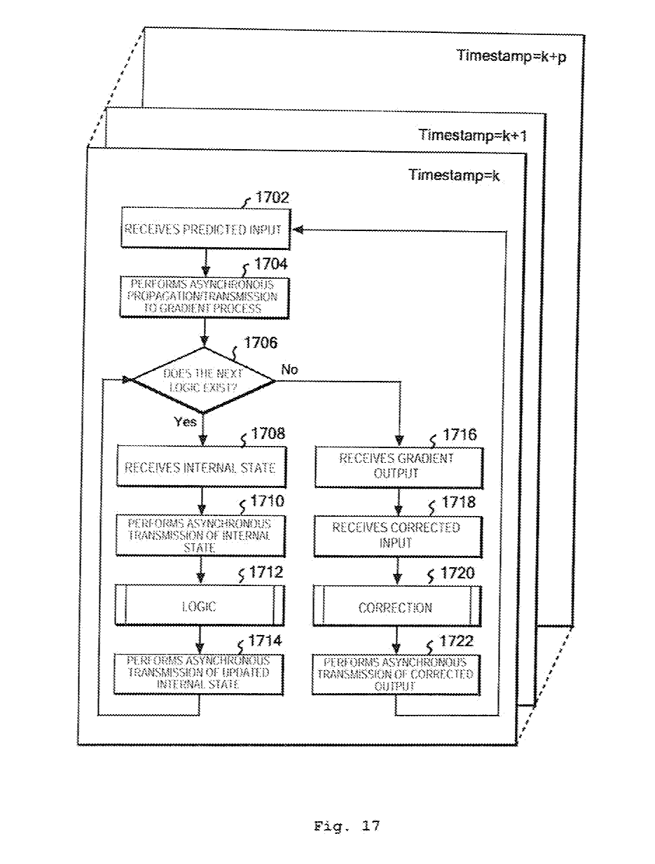

FIG. 16 is a flowchart of the master process 1402 in the system in FIG. 14. In FIG. 16, a certain initial value k_{INI} is given to k at step 1602. Here, p denotes the number of processors, and it is identical to p in FIG. 14. In the processing in this figure, p main processes perform calculation within the range of timestamp=k . . . k+(p−1) in parallel.

The master process predicts an input for the next time stamp (k+p) at step 1604, and it asynchronously sends the input to a main process in charge at step 1606. The main processes in charge is a process which is currently executing timestamp=k. To predict the input, Linear interpolation, Lagrange interpolation or the like described before is used.

Next, at step 1608, the master process waits for an output of the processor in charge of timestamp=k, which is to end processing first, and receives the output. The master process waits for synchronization purpose here.

At step 1610, the master process executes the external logic 1504 (FIG. 15) which is not directly related to the speculative pipelining processing.

At step 1612, the master process determines whether k>=k_{FIN} is satisfied. If it is satisfied, the processing of the master process is completed. If k>=k_{FIN} is not satisfied, the master process asynchronously transmits the output of timestamp=k from the external logic, to a processor in charge of timestamp=k+1 at step 1614.

When the process in charge of timestamp=k ends processing of the time step, it becomes in charge of timestamp=k+p next. In this case, because a predicted input has already arrived, the process starts processing at once without a rest.

The above is a method for causing p processes to operate simultaneously in parallel without making them wait, and a predicted input is processed beforehand. In FIG. 16, the input of timestamp=k+p is predicted before receiving the output of timestamp=k. This is because it is intended to typically describe the state of the parallel processing described above.

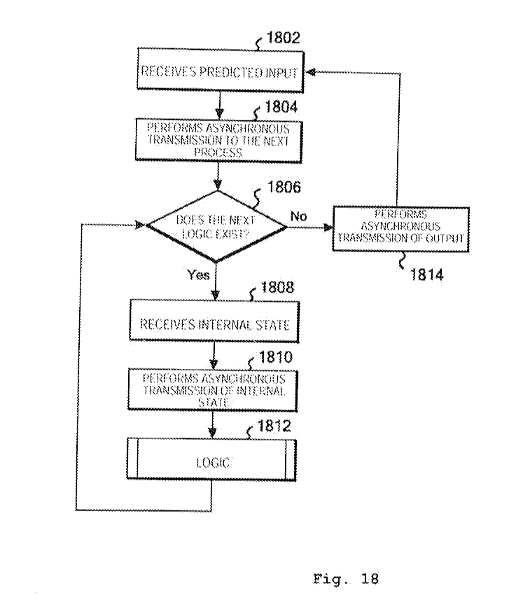

FIG. 17 is a flowchart showing processing of the main processes (FIG. 14) at time stamps (Timestamp=k, k+1, . . . , k+p).

At step 1702, the main process receives a predicted input from the master process. At step 1704, the main process performs asynchronous propagation and transmission of the predicted input received at step 1702 to a gradient process as it is.

At step 1706, the main process determines whether the next logic exists or not. Here, the logic is what is denoted by the logic A, the logic B, . . . , or the logic Z in FIG. 16.

If the main process determines that the next logic exists, the flow proceeds to step 1708, where it receives an internal state to be used by the main process from a main process in charge of the immediately previous time step. At step 1710, the received internal state is asynchronously transmitted to the gradient process as it is.

At step 1712, the main process executes the processing of a predetermined logic. Then, at step 1714, the main process asynchronously transmits the internal state updated as a result of execution of the logic, to a main process in charge of processing of the next time step.

If the main process determines that the next logic does not exist at step 1706, it proceeds to step 1716 and receives a gradient output from the last gradient thread.

At step 1718, the main process receives a corrected input. The corrected input is, for example, the output uₖ of the previous time step which has been corrected and which is outputted from block 1112, when FIG. 11 is taken as an example.

At step 1702, the main process corrects a final output value of the logic with the corrected input uₖ and a gradient output Ĵ_{f}(ûₖ). Furthermore, at step 1722, the main process sends the output corrected in that way to the master thread via asynchronous communication and returns to step 1702.

FIG. 18 is a flowchart showing processing of the Jacobian threads shown in FIG. 14. At step 1802, the Jacobian thread receives a predicted input. For example, this corresponds to the Jacobian threads 1104_1, 1104_2, . . . , 1104_n receiving a predicted input from block 1106 in FIG. 11.

In the case of the configuration shown in FIG. 14, Jacobian threads in a Jacobian thread group for one main process are serially connected. Therefore, at step 1804, an output is asynchronously propagated and transmitted to a Jacobian thread which is the next process.

At step 1806, the Jacobian thread determines whether the next logic exists or not. Processing of the Jacobian thread is actually processing for executing processing of the simulation model itself while slightly changing an input value. The logic stated here is synonymous with the logic described so far.

If it is determined at step 1806 that the next logic exists, the first Jacobian thread and the subsequent Jacobian threads receive an internal state from the main thread and the Jacobian threads immediately before them, respectively. At step 1810, the internal state is asynchronously transmitted to the next Jacobian thread. At step 1812, a predetermined logic is executed.

If it is determined at step 1806 that the next logic does not exist, an output is asynchronously transmitted to the next Jacobian thread. However, the last Jacobian thread performs asynchronous transmission to the main thread. In this case, this Jacobian thread also transmits outputs received from Jacobian threads before this Jacobian thread to the next Jacobian thread at the same time. Therefore, the last Jacobian thread asynchronously transmits output results of all the Jacobian threads to the main thread. After that, the flow returns to step 1802 again.

Although an embodiment of the present invention has been described on the basis of examples such as SMP and a torus configuration, it should be understood that the present invention is not limited to the above-described embodiments, and various configurations and techniques for which variation or replacement has been made and which those skilled in the art can think of are applicable. For example, the present invention is not limited to the architecture, operating system and the like of a particular processor. Furthermore, those skilled in the art will also understand that the present invention is applicable to any multi-process system, a multi-thread system and a system in which those systems are hybridly parallelized.

Furthermore, although the above embodiment mainly relates to parallelization in a simulation system for SILS for automobiles, it will be apparent to those skilled in the art that the present invention is not limited thereto and is applicable to simulation systems for physical systems for airplanes, robots and others.

What is claimed is:

1. A computer-implemented pipeline execution system for executing loop processing in a multi-core or a multiprocessor computing environment, wherein said loop processing includes multiple function blocks in a multiple-stage pipeline manner, said system comprising:
a pipelining unit for pipelining said loop processing and assigning said loop processing to a computer processor or core;
a calculating unit for calculating a first-order gradient term from a value calculated with the use of a predicted value of the input to a pipeline; and
a correcting unit for correcting an output value of said pipeline with said value of said first-order gradient term.

2. The pipeline execution system according to claim 1, further comprising a handling unit for handing over the value of an internal state of pipeline processing from a processor or core in charge of said pipeline processing to a processor or core in charge of the next-stage pipeline processing.

3. The pipeline execution system according to claim 1, wherein said function blocks have multiple input variables, and said first-order gradient term is indicated by an approximation formula of a Jacobian matrix related to said multiple input variables.

4. The pipeline execution system according to claim 3, wherein processing for calculating said approximation formula of said Jacobian matrix is performed as a separate thread, and said separate thread is assigned to a processor or core different from said processor or core to which said loop processing is assigned.

5. The pipeline execution system according to claim 1, wherein said predicted value is calculated by linear interpolation or Lagrange interpolation of the value of a previous-stage pipeline.

6. The pipeline execution system according to claim 4, wherein said pipeline execution system has an architecture in which nodes are three-dimensionally connected like a torus, and said separate thread for calculating said approximation formula of said Jacobian matrix is assigned to a separate node along a dimension of said three dimensions.

7. A pipeline execution method of executing loop processing in a multi-core or a multiprocessor computing environment, wherein said loop processing includes multiple function blocks in a multiple-stage pipeline manner, said method comprising:
pipelining said loop processing and assigning said loop processing to a computer processor or core;
calculating a first-order gradient term from a value calculated with the use of a predicted value of the input to a pipeline; and
correcting an output value of said pipeline with said value of said first-order gradient term.

8. The pipeline execution method according to claim 7, further comprising handing over the value of an internal state of pipeline processing from a processor or core in charge of said pipeline processing to a processor or core in charge of the next-stage pipeline processing.

9. The pipeline execution method according to claim 7, wherein said function blocks have multiple input variables, and said first-order gradient term is indicated by an approximation formula of a Jacobian matrix related to said multiple input variables.

10. The pipeline execution method according to claim 9, wherein processing for calculating said approximation formula of said Jacobian matrix is performed as a separate thread, and said separate thread is assigned to a processor or core different from said processor or core to which said loop processing is assigned.

11. The pipeline execution method according to claim 7, wherein said predicted value is calculated by linear interpolation or Lagrange interpolation of the value of a previous-stage pipeline.

12. A computer-implemented pipeline execution program product for executing loop processing in a multi-core or multiprocessor computing environment, wherein said loop processing includes multiple function blocks in a multiple-stage pipeline manner, said pipeline execution program product comprising computer program instructions for carrying out the steps of:
pipelining said loop processing and assigning said loop processing to a computer processor or core;
calculating a first-order gradient term from a value calculated with the use of a predicted value of the input to a pipeline; and
correcting an output value of said pipeline with said value of said first-order gradient term,
wherein said computer program instructions are stored on a computer readable storage medium.

13. The pipeline execution program product according to claim 12, wherein said computer program instructions further carry out the step of handing over the value of an internal state of pipeline processing from a processor or core in charge of said pipeline processing to a processor or core in charge of the next-stage pipeline processing.

14. The pipeline execution program product according to claim 12, wherein said function blocks have multiple input variables, and said first-order gradient term is indicated by an approximation formula of a Jacobian matrix related to said multiple input variables.

15. The pipeline execution program product according to claim 14, wherein processing for calculating said approximation formula of said Jacobian matrix is performed as a separate thread, and said separate thread is assigned to a processor or core different from said processor or core to which said loop processing is assigned.

16. The pipeline execution program product according to claim 12, wherein said predicted value is calculated by linear interpolation or Lagrange interpolation of the value of a previous-stage pipeline.
